(19) United States
(12) Patent Application Publication
(10) Pub. No.: US 2007/0091061 A1
(43) Pub. Date: Apr. 26, 2007

(54) Electrophoretic display device and method for manufacturing such a device

(75) Inventors: Lucas Josef Maria Schlangen, Eindhoven (NL); Roel Penterman, Eindhoven (NL); Dirk Jan Broer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/560,009

(22) PCT Filed: Jun. 4, 2004
(86) PCT No.: PCT/IB04/50843

§ 371 Date: Dec. 8, 2005

(30) Foreign Application Priority Data
Jun. 13, 2003 (EP) 03101732.0

(51) Int. Cl. G09G 3/34

(52) U.S. Cl. 345/107

(57) ABSTRACT

The invention relates to an electrophoretic display panel (11) comprising one or more pixels (20; 42) comprising a fluid with dispersed charged particles (30) and a polymer wall (21; 44) enclosing the fluid. The invention further relates to a method for manufacturing an electrophoretic display panel (11) comprising one or more pixels (20; 42) comprising the steps of providing a material system comprising a fluid with dispersed charged particles (30) and a photo-polymerizable substance and exposing one or more selected portions of said material system to radiation to form a polymer wall (21; 44) enclosing the fluid by polymerizing said photo-polymerizable substance.

The invention relates to an electrophoretic display device comprising one or more pixels comprising a fluid with dispersed charged particles.

WO 01/02899 discloses an electrophoretic medium comprising a layer of capsules. Each of the capsules comprises a liquid and particles disposed within the liquid that are capable of moving within the capsule upon application of an electric field. The capsules are provided between substrates that are separated from each other by a plurality of spacers. The spacers are formed from a transparent material, such as a polymeric material. The encapsulated electrophoretic medium is used for manufacturing an electrophoretic display.

A problem associated with the prior art display panel is that the capsules comprising the fluid and the dispersed particles generally are not uniform in size. As a consequence the application of a voltage yields different electric fields for each of the capsules such that the optical behaviour is likely to vary from capsule to capsule. As a pixel usually comprises several capsules grey scale generation proves to be difficult.

It is an object of the invention to provide an electrophoretic display panel that can be controlled better with respect to optical behaviour.

This object is achieved by an electrophoretic display panel comprising a polymer wall enclosing the fluid. As the pixels are determined by the polymer wall enclosing the fluid with dispersed particles, capsules are no longer needed, resulting in a better control of the optical behaviour of the pixel and the display panel comprising such pixels.

Advantageous embodiments of the electrophoretic display panel are defined in the dependent claims.

The invention further relates to a display device comprising such an electrophoretic display panel and circuitry to provide image information to said display panel. Such devices include handheld devices, such as Personal Digital Assistants (PDA's) and electronic books, that require optimal legibility.

The invention further relates to a method for manufacturing an electrophoretic display panel comprising one or more pixel comprising the steps of:
providing a material system comprising a fluid with dispersed charged particles and a photo-polymerizable substance;
exposing one or more selected portions of said material system to radiation to form a polymer wall enclosing the fluid by polymerizing said photo-polymerizable substance.

In this method the polymerizable substance will diffuse away from the area that will function as the active pixel area in order to form the polymer wall. As the pixels are determined by the polymer wall enclosing the fluid with dispersed particles, capsules are no longer needed, resulting in a better control of the optical behaviour of the pixel and the display panel comprising such pixels.

In a preferred embodiment of the invention the method further comprises the steps of forming an electrode structure on or over the material system to define the selected portions and to expose said selected portions of said material system to said radiation to form said polymer wall. By irradiating such a system, only the areas between the electrode structure may be irradiated such that polymerisation will substantially only occur in these areas. It is noted that alternatively a separate photomask can be provided for defining the selected portions to radiation in order to form the polymer wall. However, in using the electrode structure of the pixel, a self-aligned mask is obtained. In case the electrode structure is defined directly on top of the material system, enhanced resolution is achieved as well as finer patterning.

In an embodiment of the invention the method further comprises the steps of positioning the dispersed charged particles by applying a voltage to define said selected portions and exposing said thus defined selected portions of said material system to said radiation to form said polymer wall. The particles may shield the underneath area from radiation. The polymerizable substance diffuses to the irradiated areas to constitute polymer walls determining the pixel. In this embodiment the selected portions are defined from the material system itself, resulting in optimal resolution. It is noted that the applied voltage is not necessarily maintained over the system during exposure to the radiation, since for a bi-stable fluid, the particles may remain in position after removal of the voltage. It is further noted that usage of the dispersed charged particles to define the selected portions may be combined with a photo-mask or use of the electrode structure to define the selected portions as described in the previous paragraph.

In an embodiment of the invention the method further comprises the steps of providing said material system on or over a substrate and forming a counter-substrate from said material system by exposure of said material system to radiation. Such a method is also referred to as photo-induced stratification, i.e. phase separation into a layered structure. In this embodiment the counter-substrate is obtained from the material system as a hard polymer film on top of the pixel. Preferably the material system is first exposed to a first radiation beam to manufacture the polymer wall. This first radiation beam has parameters, such as intensity and wavelength, adapted to define the polymer walls and to avoid initiation of the stratification. Subsequently a second radiation beam with different parameters is applied to form the counter-substrate. The process results in the formation of polymer boxes filled with a fluid with dispersed charged particles. The boxes comprise polymer walls being formed by the first radation beam beam and a polymer cover obtained by exposure to the second radiation beam, i.e. the stratification process.

In an embodiment of the invention the material system comprises polymerisation-inhibitors to minimize polymerisation in the areas that are not directly exposed to the radiation. Such a material system is advantageous since radiation beams may reflect within the pixel structure during radiation, resulting in initiation of a polymerisation reaction in undesired areas. This advantage especially holds for low intensity radiation beams.

In an embodiment of the invention the fluid is a liquid crystal. During the polymerisation step a liquid crystal phase is separated from the initially isotropic mixture due to the presence of monomer. The fact that a liquid crystal is phase separated enhances the process of phase separation during the wall formation, but especially during the stratification step, because of the liquid crystal's elastic forces, such that the liquid areas, also containing the charged particles, remain free from polymer. The display that is formed now contains charged particles being moved by an electrical field in a liquid crystal liquid. This as such may enhance the switching characteristics of the display because of the low shear viscosity of the liquid crystal.

In yet another embodiment of the invention the formation of the liquid crystalline phase only occurs at temperatures below the actual operating temperature of the display by radiation at low temperatures, e.g. −20° C. By heating to the operating temperature, e.g. room temperature, the liquid crystal becomes isotropic again, now acting as a conventional liquid. In this case the liquid crystal phase assists in freeing the liquid region from potential polymers being formed.

U.S. Pat. No. 6,097,458 discloses a reflective liquid crystal display, wherein the display medium includes a liquid crystal material and polymer walls. The polymer walls are wall-like rigid structures of polymer material for separating the pixels. The publication however does neither relate to an electrophoretic display nor discloses the problem of capsules within a pixel with respect to control of the optical behaviour of such a display.

The invention will be further illustrated with reference to the attached drawings, which show preferred embodiments of the invention. It will be understood that the device and method according to the invention are not in any way restricted to this specific and preferred embodiment.

In the drawings:

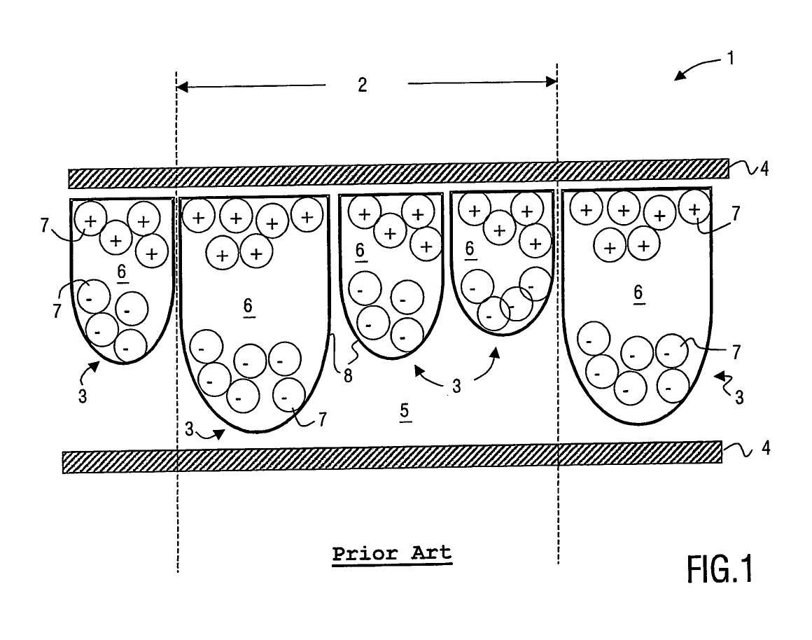

FIG. 1 shows an electrophoretic display panel known from the prior art;

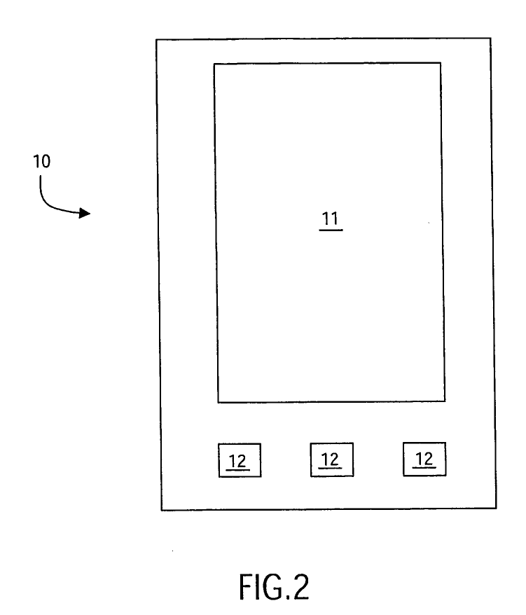

FIG. 2 shows an electric device comprising a display panel with pixels according to the invention;

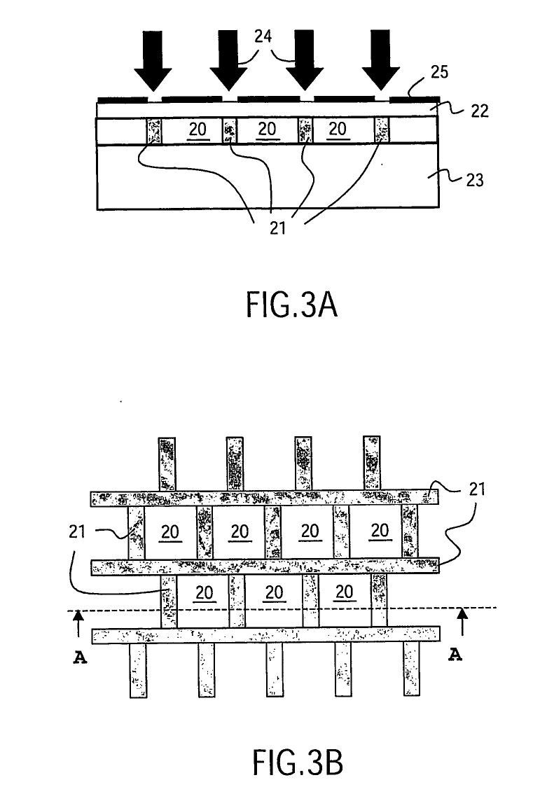

FIG. 3 shows a plurality of pixels manufactured according to a first embodiment of the invention;

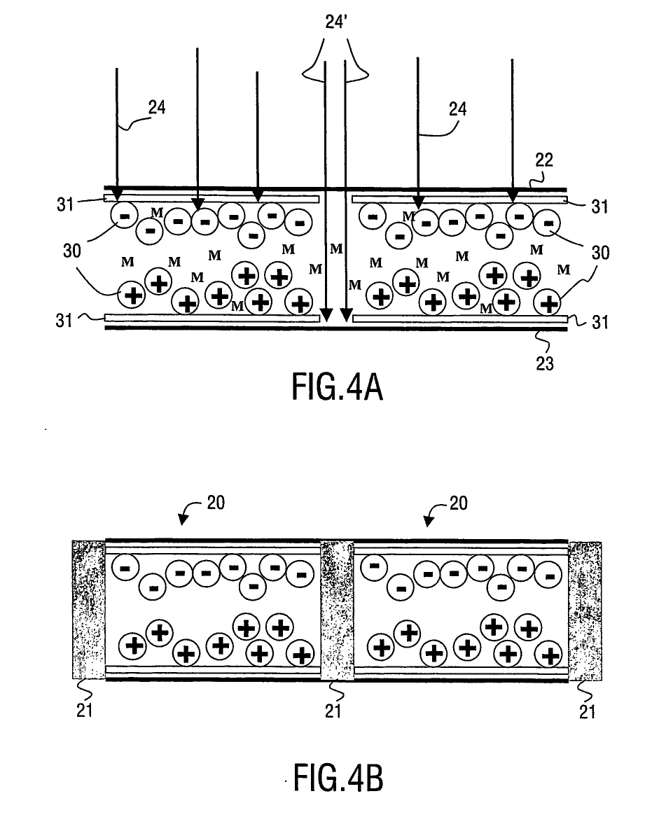

FIG. 4 shows a pixel manufactured according to a second embodiment of to the invention;

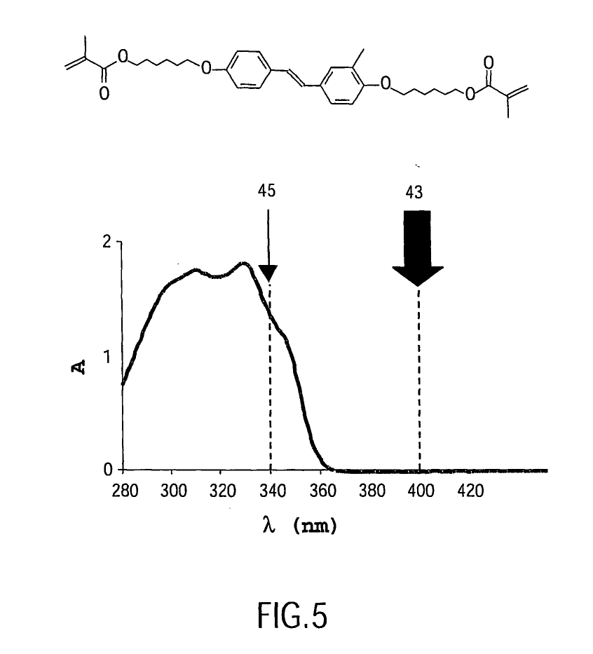

FIG. 5 shows a stilbene-dimethacrylate molecule and an absorption diagram for such a molecule, and

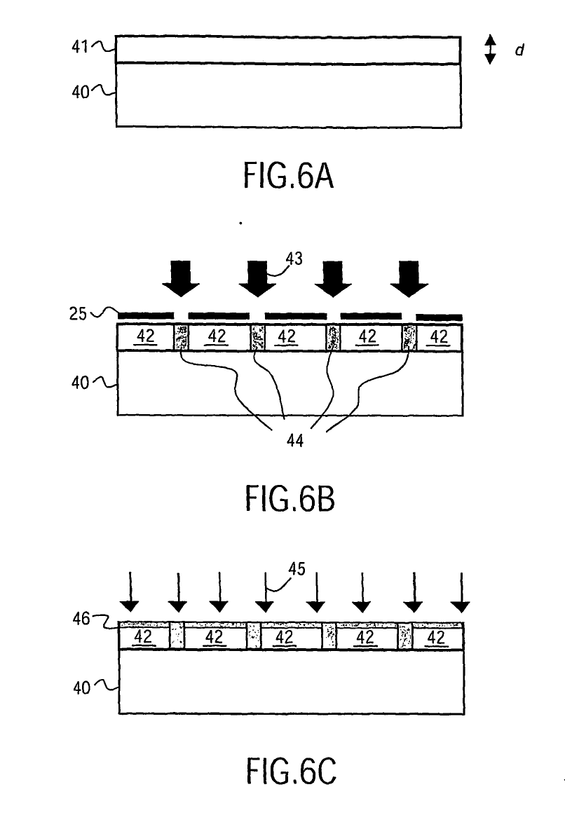

FIG. 6 shows a pixel manufactured according to a third embodiment of the invention.

FIG. 1 shows a prior art display panel 1 comprising a plurality of pixels 2. A pixel 2 comprises a plurality of capsules 3 sandwiched between two substrates 4. The capsules 3 are embedded in a polymeric binder 5. The capsules 3 comprise a solvent 6 and charged particles 7, the charge of which is indicated by the respective signs. The particles can be moved from and towards the substrates by applying an electric field. By making the positive particles black and the negative particles white, such an electric field may be used to obtain optical effects, such as switching the display panel 1 from black to white.

As schematically illustrated in FIG. 1, a problem associated with such a display panel 1 is that the capsules 3 are not uniform in size. This implies that the voltage drop over the capsules 3 is not constant for all capsules 3, such that the electro-optical behaviour may vary from capsule to capsule. One capsule 3 may switch from black to white at a different voltage or electric field than another capsule 3. As an individual pixel 2 usually comprises more than one capsule 3, as indicated by the dashed lines, grey scale production proves to be difficult. The non-uniformity of the capsules 3 within a pixel 2 limits the number of possible grey scales. Moreover, the fact that a pixel 2 includes several capsules 3 gives rise to capsule walls 8 within such a pixel 2. These walls 8 limit the maximum reflectivity that can be achieved in such a display panel 1.

FIG. 2 shows a device 10 comprising a display panel 11 and control features 12 according to the invention. The display panel 11 is an electrophoretic display panel. The device 10 may e.g. refer to an electronic book. Electrophoretic display panels are generally more legible than liquid crystal displays (LCD's) in terms of brightness and contrast. Moreover electrophoretic display panels 11 have demonstrated to be easily readable with incident environmental light from various directions.

FIG. 3 shows in cross-section under (A) a manufacturing step for manufacturing pixels 20 determined by polymer walls 21 of an electrophoretic display panel 11, as schematically illustrated under (B) in top-view. The material system comprises e.g. a solvent (like a hydrocarbon and fluorocarbon mixture), positively charged black (like carbon black) and negatively charged white pigment particles (like TiO₂) and charging agents (like aerosol OT (AOT), a bis (2-ethylhexyl) sodium sulfosuccinate (C20H37O7SNa) of Aldrich, or polyisobutylene succinimide). Furthermore a photo initiator and polymerizable substance are added. Such a material system is e.g. 80 wt % (5 wt % carbon black particles in CB6 hydrocarbon solvent (Calcomp)), 15.1 wt % isobornylacrylate monomer, 4 wt % R-684 dimethacrylate monomer (crosslinker), 0.5% Darocure 4265® (photoinitiator). First the mixture is applied between two glass substrates 22, 23 provided with ITO electrodes that are kept e.g. 20 μm apart. The selected portions of the material system are subsequently exposed to UV radiation 24 through a mask 25 that is applied directly on the upper substrate 22 defining selected portions. During the UV exposure an electric field of 5 V DC was kept over the cell. As a result the carbon black particles moved towards the bottom substrate 23. This was done to minimise the influence of the particles on the diffusion processes and minimise scattering of UV light. The thus irradiated system separates the material system such that the polymerizable substance, i.e. the monomers, diffuse away from the active pixel areas 20 to polymerise in order to form the polymer walls 21 enclosing the fluid. Wall formation was observed in the areas where the mask 25 was transparent. Particles that where present in the areas shielded by the mask could be moved up and down in the cell afterwards when a positive/negative electric field was applied over the ITO electrodes. The display panel 11 obtained has a matrix configuration of pixels 20 determined by polymeric walls 21.

Instead of a hydrocarbon solvent, a liquid crystal solvent can be used. The use of a liquid crystal may be useful to improve bi-stability in the display. With a voltage applied the liquid crystal aligns and the charged particles can move easily along the long axis of the liquid crystal molecules, perpendicular to the substrates 22, 23. Without an applied voltage the liquid crystal can either form domains with random orientations or align parallel to the substrates 22,23.

The use of a liquid crystalline solvent may reduce the contrast of the display panel 1, because variations of the refractive index around the dispersed charged particles (not shown) result in scattering of incident light. This scattering effect may be reduced by using a liquid crystal which has a low birefringence. The following material system can be used: 80 wt % liquid crystal E7 (Merck®), 15.3 wt % isobornylacrylate monomer, 4 wt % R-684 (Kayarad®) diacrylate monomer, 0.2 wt % TEMPO (inhibitor), 0.5% Darocure 4265®) photoinitiator (Ciba-Geigy). In order to obtain an electrohoretic display, particles are needed within the pixels 20. This can be done by mixing the mixture described above with for example carbon black particles. The surfaces of the particles preferably are chemically modified to obtain a stable dispersion to avoid coalescence and sedimentation of the particles, both before and after the phase separation.

Another option is to use a liquid crystal that is isotropic at temperatures at which the display device 10 is operated and is liquid crystalline at much lower temperatures. The manufacturing process of the display panel 11 then is carried out at those lower temperatures using the change in elastic energy of the liquid crystal as an extra driving force during the phase separation.

FIG. 4 shows a second embodiment of the invention wherein two pixels 20 are manufactured by exposing a material system to radiation 24. The material system between the substrates 22, 23 comprises a fluid with dispersed charged particles 30 and a polymerizable substance, indicated by the monomers M. Further, an electrode structure 31 is provided.

FIG. 4 shows under (A) and (B) three alternatives for manufacturing a display panel 11. Instead of a photo-mask 25 as shown in FIG. 3, FIG. 4 first shows that the electrode structure 31 may be used to define the selected portions for exposure to the radiation 24. The material system separates as a result of the intruding radiation beams 24′ such that the monomers M polymerise in the exposed areas in order to form the polymer walls 21 enclosing the fluid shown in FIG. 4 under (B). Here a radiation wavelength is selected at which the electrode structure 31 absorbs the radiation 24 and the glass or plastic substrate 22, 23 transmits the radiation 24. The ratio between the light intensity transmitted by the substrate 22 and the light transmitted by the electrode structure 31 is the contrast ratio. This contrast ratio preferably is sufficiently high, for instance 50. However, lower contrast ratios are also useable when the blend containing liquid, monomer, particles, etc. also contains the polymerisation inhibitor. The polymerisation inhibitor makes the response of the polymerising medium highly non-linear to the radiation intensity. A suitable wavelength is 330 nm.

Secondly FIG. 4 shows that the dispersed charged particles 30 themselves may act as a switchable mask. This can be achieved by providing an electric field to the particles 30, e.g. by applying a voltage to the electrode structure 31, such that e.g. the negatively charged particles 30 define the selected portions by taking an appropriate position. It is noted that in case of a bi-stable solvent, continuous application of a voltage may not be necessary as the particles 30 remain in position after removal of the electric field.

Finally the dispersed charged particles 30 and the electrode structure 31 can be used both for defining the selected portions.

For the embodiments shown in FIGS. 3 and 4 the material system was provided between two substrates 22, 23. In a third embodiment of the invention photo-induced stratification is used for provisioning a substrate. Photo-induced stratification is a single-substrate technique and is already described in WO 02/48281 of the applicant.

FIG. 5 shows a stilbene-dimethacrylate molecule that is added to the material system for stratification purposes. Such a material system may e.g. comprise 50 wt % particle containing solvent for example dodecane, 5 wt % stilbene-dimethacrylate, 44.5 wt % isobornylmethacrylate and 0.5 wt % photo-initiator IRG651 (Ciba-Geigy®). FIG. 5 moreover shows an optical absorption diagram for such a molecule.

FIG. 6 shows under (A) a single substrate 40 having a film 41 comprising the material system described in the previous paragraph deposited thereon. Film-forming techniques such as the doctor blade technique or slot die coating, that are known for fast coating of both small and large areas, can be used to apply the film 41.

The pixels 42 are obtained in a two step radiation process. The material system comprising a particle containing solvent and polymerizable substance is applied as a thin film 41 with a thickness d of about 20 μm onto a glass substrate 40. The wet film 41 is exposed through a mask 25 to a first radiation beam 43, e.g. high-intensity light of 400 nm. This wavelength is outside the absorption region of the stilbene-dimethacrylate, as indicated in FIG. 5 and therefore no intensity gradient exists over the film thickness d. Polymerisation in the exposed areas results in the formation of polymer walls 44, as shown in FIG. 6 under (B).

Subsequently, the unexposed areas are exposed to a second radiation beam 45, e.g. UV light of 340 nm. At this wavelength the stilbene-dimethacrylate exhibits significant absorption, as indicated in FIG. 5. A much lower intensity is chosen to slow down the polymer network formation which gives the materials time to stratify in the vertical direction, as shown in FIG. 6 under (C). As a result, the photo-polymerisation predominantly takes place where the UV intensity is the highest i.e. near the film surface that is directed towards the UV source (not shown). This in turn induces a diffusion of monomers in the film in the upward direction and a diffusion of dodecane molecules in the reverse direction, i.e. towards the substrate 40. As a result a continuous hard polymer film is obtained as a counter-substrate 46. During this process the particles (not shown) need to be fixated on the substrate 40 to prevent them from being trapped in the polymer top film 46. This can be done by applying an electrical or magnetic field over the film 41, e.g. by Corona discharging.

The process finally results in the formation of polymer boxes filled with a particle containing solvent. The boxes consist of polymer walls 44 that have been formed during the first phase separation step and the polymer cover 46 that has been formed at the second phase separation step, i.e. the stratification step.

The invention is not restricted to the above described embodiments which can be varied or expanded in a number of ways within the scope of the claims, by e.g. using a liquid crystalline solvent for the embodiment of FIG. 6 instead of an isotropic solvent to enhance the phase separation and/or improve the bi-stability of the display panel 11. When a liquid crystalline state of the solvent is desirable during operating temperatures the following material system could be used: 50 wt % particle containing E7 (Merck®), 5 wt % stilbene-dimethacrylate, 44.5 wt % isobornylmethacrylate and 0.5 wt % photoinitiator IRG651 (Ciba-Geigy®).

1. An electrophoretic display panel (11) comprising one or more pixels (20;42) comprising a fluid with dispersed charged particles (30) and a polymer wall (21;44) enclosing the fluid.

2. The electrophoretic display panel (11) according to claim 1, wherein said display panel (11) comprises electrodes (31) for said pixels (20;42) and said polymer wall (21;44) extends between said electrodes (31).

3. The electrophoretic display panel (11) according to claim 1, wherein said display panel (11) comprises electrodes (31) for said pixels (20;42) and said display panel (11) is substantially free of said dispersed charged particles (30) between said electrodes (31).

4. The electrophoretic display panel (11) according to claim 1, wherein said electrophoretic display panel (11) comprises a substrate (46), said substrate (46) and said polymer wall (44) being integrally formed.

5. A display device (10) comprising an electrophorectic display panel (11) according to claim 1 and circuitry to provide image information to said display panel (11).

6. A method for manufacturing an electrophoretic display panel (11) comprising
one or more pixels (20;42) comprising the steps of:
providing a material system comprising a fluid with dispersed charged particles (30) and a photo-polymerizable substance;
exposing one or more selected portions of said material system to radiation to form a polymer wall (21;44) enclosing the fluid by polymerizing said photo-polymerizable substance.

7. The method according to claim 6, further comprising the steps of forming an electrode structure (31) on or over said material system to define said selected portions and exposing said selected portions of said material system to said radiation to form said polymer wall (21;44).

8. The method according to claim 6, further comprising the steps of positioning said dispersed charged particles (30) by applying a voltage to define said selected portions and exposing said thus defined selected portions of said material system to said radiation to form said polymer wall (21;44).

9. The method according to claim 6, wherein said material system comprises a solvent and exposing to said radiation is performed at a temperature wherein said solvent is in a liquid crystalline state.

10. The method according to claim 6, wherein said material system further comprises polymerisation-inhibitors.

11. The method according to claim 6, further comprising the steps of providing said material system on or over a substrate (22;40) and forming a counter-substrate (46) from said material system by exposure of said material system to radiation.

12. The method according to claim 6, further comprising the steps of providing said material system on or over a substrate (22;40), irradiating said material system with a first radiation beam (43) to form said polymer wall and irradiating said material system with a second radiation beam (45) to form a counter-substrate (46).
